(19) United States
(12) Patent Application Publication
(10) Pub. No.: US 2026/0260562 A1
(43) Pub. Date: Sep. 3, 2026

(54) Methods and Apparatuses for Remote Control of Controllable Electrical Devices in a Surrounding Physical Environment of a User

(71) Applicant: Telefonaktiebolaget LM Ericsson (publ), Stockholm (SE)

(72) Inventors: Tommy Arngren, Södra Sunderbyn (SE); Peter Ökvist, Luleå (SE); Andreas Kristensson, Södra Sandby (SE)

(21) Appl. No.: 19/165,223

(22) PCT Filed: Mar. 22, 2023
(86) PCT No.: PCT/SE2023/050251

§ 371 Date: Sep. 15, 2025

(51) Int. Cl. G08C 17/02; G06F 3/01; G06F 3/041; G06F 3/0488; G06T 11/00; G06V 20/52; H04W 8/00

(52) U.S. Cl. CPC G08C 17/02; G06F 3/013; G06F 3/017; G06F 3/0416; G06F 3/0488; G06T 11/00; G06V 20/52; H04W 8/005

(57) ABSTRACT

A technique for discovery and control of electrical devices (18) that are remotely controllable within a surrounding physical environment (12) of a user (14) offers several advantages, including intelligent automation of device discovery and corresponding adaptation of a user interface (46, 62) to act as a control input for remotely controlling the electrical device (18). An electrical device that is remotely controllable may be regarded as a “smart device,” such as a ceiling fan having a network-accessible actuator for on/off and speed control. In this context, “adaptation” refers to tailoring the user interface (46, 62) for the particular remote controls available for the electrical device (18) to be controlled. Such tailoring and even initial determinations of whether, or in what ways, an electrical device (18) is remotely controllable may be based on a portable electronic device (10) of the user (14) determining whether a digital actuation function (104) is available for an electrical device (18) detected in the surrounding physical environment (12).

### TECHNICAL FIELD

Disclosed methods and apparatuses relate to remote control of controllable electrical devices in a surrounding physical environment of a user.

### BACKGROUND

Various electrical devices in a surrounding physical environment may be controllable via remote control. For example, a ceiling fan includes or is associated with a “smart controller” that turns the fan on or off or controls the fan speed, responsive to receiving remote control commands. Here, the smart controller is an electronic device that includes communication and processing circuitry for receiving and responding to incoming remote control commands, and further includes a control interface for controlling an associated electrical device. The smart controller may be networked, allowing it to be reached via the Internet, or it may be reachable via local wireless signaling. An electrical device that includes or is associated with a smart controller may be referred to as being a “smart device.” The terms “responsive electrical device”, “responsive device”, “controllable electrical device”, “controllable device”, and “smart device” are used interchangeably unless otherwise noted, with all such terms denoting an electrical device that is controllable via remote control commands.

Depending upon the type of controllable device, control may be limited to on/off control. Other types of controllable devices offer more sophisticated control, such as speed in the context of fans or other motorized devices, or brightness in the context of lamps, bulbs, or other illumination devices. In this sense, a controllable electrical device may be an electro-mechanical apparatus.

One challenge for users is not necessarily knowing which electrical devices in their surrounding physical environment are smart devices, and this problem is particularly acute when a user is outside their home, such as when the user is located in an office building. Further, even when a user is in a familiar space, remotely controlling an electrical device may be challenging. For example, the conventional actions needed to control an electrical device may be incompatible with or disruptive to an ongoing Virtual Reality (VR) or Augmented Reality (AR) experience.

### SUMMARY

A technique for discovery and control of electrical devices that are remotely controllable within a surrounding physical environment of a user offers several advantages, including intelligent automation of controllable device discovery and corresponding adaptation of a user interface to act as a control input for remotely controlling the electrical device. In this context, “adaptation” refers to tailoring the user interface for the particular remote controls available for the electrical device to be controlled. Such tailoring and even initial determinations of whether, or in what ways, an electrical device is remotely controllable may be based on a portable electronic device of the user determining whether a digital actuation function is available for an electrical device detected in the surrounding physical environment.

An example embodiment comprises a method of operation by a portable electronic device. The method includes determining whether an electrical device deemed to be of interest to a user carrying or wearing the portable electronic device is remotely controllable by the portable electronic device, where the electrical device is in a surrounding physical environment of the user. The method further includes, responsive to determining that the electrical device is remotely controllable by the portable electronic device, adapting a user interface of the portable electronic device or a companion electronic device to act as a control input for remotely controlling the electrical device, and transmitting signaling conveying remote control commands corresponding to user inputs received via the control input, for remote control of the electrical device.

A related example embodiment comprises a portable electronic device. The device includes communication circuitry and processing circuitry. The processing circuitry is configured to: (1) determine whether an electrical device deemed to be of interest to a user carrying or wearing the portable electronic device is remotely controllable by the portable electronic device, wherein the electrical device is in a surrounding physical environment of the user; and (2) responsive to determining that the electrical device is remotely controllable by the portable electronic device, (a) adapt a user interface of the portable electronic device or a companion electronic device to act as a control input for remotely controlling the electrical device, and (b) transmit, via the communication circuitry, signaling conveying remote control commands corresponding to user inputs received via the control input, for remote control of the electrical device.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram illustrating a user in a surrounding physical environment that includes one or more electrical devices, and where the user carries or wears a portable electronic device according to an example embodiment, where the portable electronic device is advantageously configured for remote control of one or more of the electrical devices.

FIGS. 2, 3A, 3B, 4A, and 4B are block diagrams of example implementation details for a portable electronic device, according to various embodiments.

FIG. 5 is a block diagram of a companion device, according to example details.

FIGS. 6, 7, and 8 are block diagrams illustrating operations and signaling associated with remote control of one or more electrical devices, according to example embodiments.

FIGS. 9 and 10 are block diagrams illustrating virtual reality (VR) based remote control of an electrical device, according to an example embodiment.

FIG. 11 is a block diagram of a portable electronic device configured to communicate with a wireless communication network, according to an example embodiment.

FIGS. 12, 13, and 14 are logic flow diagrams illustrating methods of operation for remote control of an electrical device present in a surrounding physical environment of a user, according to example embodiments.

### DETAILED DESCRIPTION

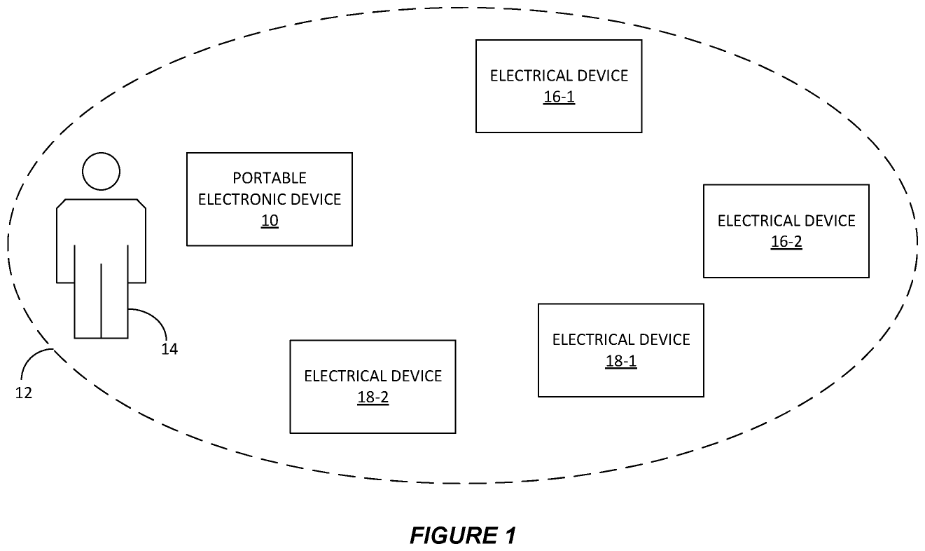

FIG. 1 illustrates a portable electronic device 10 that has advantageous features for controlling electrical devices that are within a surrounding physical environment 12 of a user 14, who is carrying or wearing the portable electronic device 10. For example, the portable electronic device 10 is a smartphone. In another example, the portable electronic device 10 is a Virtual Reality (VR) headset. Unless otherwise noted, the term “VR” encompasses Augmented Reality (AR) operation, which superimposes one or more VR elements onto an imaged scene of the real word.

There may be multiple electrical devices in the surrounding physical environment 12 of varying types. Not every electrical device or device type is remotely controllable, and FIG. 1 illustrates two example electrical devices 16-1 and 16-2 that are not remotely controllable, or at least not remotely controllable within the capabilities of the portable electronic device 10. Here, the reference number “16” does not necessarily mean that the electrical device 16-1 is of the same type as the electrical device 16-2; rather, the reference number “16” refers to electrical devices that are not remotely controllable by the portable electronic device 10.

An electrical device 16 is not controllable by the portable electronic device 10 for any number of reasons. For example, an electrical device 16 may not support any remote control, or it may not be discoverable within the capabilities of the portable electronic device 10, or there may be an absence of supporting information that enables the portable electronic device 10 to determine supported commands or required protocols. Put simply, any electrical device that does not support remote control or does not support remote control within the capabilities of the portable electronic device 10 is categorized as not remotely controllable.

Conversely, the reference number “18” in FIG. 1 identifies electrical devices that are remotely controllable by the portable electronic device 10, with two such examples appearing in the diagram as electrical devices 18-1 and 18-2. The electrical device 18-1 may or may not be of the same type as the electrical device 18-2. For example, the surrounding physical environment 12 may be a room in a house, office building, or within another type of structure, and it may contain multiple lights, fans, etc., that are controllable remotely. Of course, not all lights, fans, or other entities within the room may be remotely controllable, and not all remotely controllable items offer the same type or extent of remote control. Various embodiments disclosed herein provide for advantageous discovery and control determinations in such contexts.

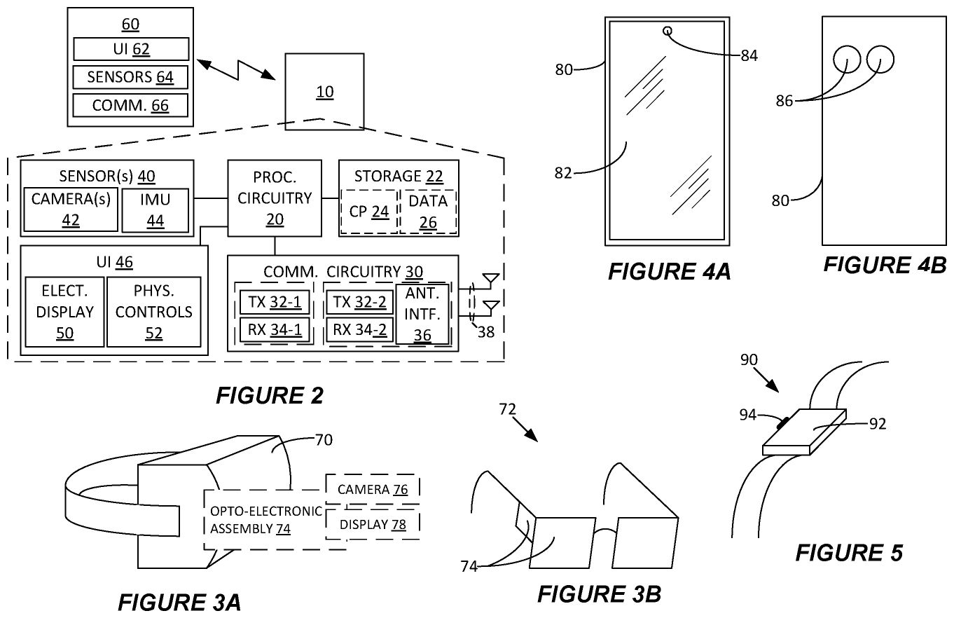

FIG. 2 illustrates a portable electronic device 10 according to one embodiment, with the portable electronic device 10 including processing circuitry 20, which may include or be associated with storage 22, e.g., for storing a computer program (“CP”) 24 and/or one or more types of data 26. For example, while not explicitly shown in the diagram, the data 26 includes information identifying defined remote control commands, protocols, device identifiers or addresses, etc., as used by the portable electronic device 10 for transmitting appropriate remote control commands. Here, referring to the portable electronic device 10 as transmitting remote control commands may be understood as the portable electronic device 10 transmitting the commands, or causing another device or entity to transmit the commands.

In an example embodiment, the processing circuitry 20 comprises one or more microprocessors, microcontrollers, digital signal processors, or other digital processing circuitry that is specially adapted to carry out the operations described herein for the portable electronic device 10, based on the execution of computer program instructions stored in memory. For example, the storage 22 comprises one or more types of memory or other computer-readable media for volatile and/or non-volatile storage of computer program instructions and working data.

Further included in the portable electronic device 10 is communication circuitry 30, which comprises one or more types of transceiver circuitry, such as for communicating over different physical mediums and/or for communicating according to different physical-layer signal types or communication protocols. In one example, a first transceiver comprises transmit circuitry 32-1 and receiver circuitry 34-1, and a second transceiver comprising transmit circuitry 32-2 and receiver circuitry 34-2. The second transceiver couples through an antenna interface 36 to one or more transmit/receive (TX/RX) antennas 38.

For example, the second transceiver is a cellular radio interface or other radio-based Wide Area Network (WAN) interface for accessing one or more types of wireless communication networks that, in turn, serve as access networks for connecting to the Internet or other data networks. In a complementary arrangement, the first transceiver is configured for “local” connectivity and provides, for example, wireless connectivity according to any one or more of the following wireless protocols/specifications: Bluetooth, Zigbee, or Thread.

In at least some embodiments, the portable electronic device 10 further includes one or more sensors 40, for sensing the surrounding physical environment 12 and/or determining its location, orientation, or movement within the environment. Example sensors include one or more cameras 42 and an Inertial Measurement Unit (IMU) 44. Still further, in at least one embodiment, the portable electronic device 10 includes a user interface (UI) 46, which may include an electronic display 50 and one or more physical controls 52. The electronic display 50 provides a mechanism for displaying images from the camera(s) 42, for example, and in one or more embodiments it comprises a touchscreen.

FIG. 2 further illustrates a companion electronic device 60, or simply “companion device.” While not used in all embodiments, the portable electronic device 10 in one or more embodiments uses a companion device 60 for one or more aspects of remotely controlling a responsive electrical device 18. For example, the companion device 60 may include a user interface 62 that is better suited or more readily adapted to serve as the control input for the user to indicate desired remote control actions, or the companion device 60 may include sensors 64 that are better suited for detecting the presence of responsive electrical devices 18 in the surrounding physical environment 12, or may include communication circuitry 66 that is better suited for communicating with responsive electrical devices 18. At a minimum, the communication circuitry 30 of the portable electronic device 10 and the communication circuitry 66 of the companion device 60 provide a communications link between them.

In an example embodiment, the processing circuitry 20 of the portable electronic device 10 is configured to: (a) determine whether an electrical device deemed to be of interest to a user carrying or wearing the portable electronic device 10 is remotely controllable by the portable electronic device 10, wherein the electrical device is in a surrounding physical environment 12 of the user 14; and (b) responsive to determining that the electrical device is remotely controllable by the portable electronic device 10: (1) adapt a user interface 46 of the portable electronic device 10 or a user interface 62 of a companion electronic device 60 to act as a control input for remotely controlling the electrical device; and (2) transmit, via the communication circuitry 30, signaling conveying remote control commands corresponding to user inputs received via the control input, for remote control of the electrical device. Here, “control input” is a noun that refers to an arrangement of physical or touchscreen controls that are purposed or repurposed for receiving user inputs that are mapped to corresponding remote control actions.

The processing circuitry 20 is configured to deem the electrical device to be of interest to the user, for example, based at least on determining that the electrical device is a type of responsive electrical device 18. Further, the processing circuitry 20 in one or more embodiments is configured to determine available remote control commands for the responsive electrical device 18 based on stored information that defines default remote control commands available for one or more types of responsive electrical devices 18 or based on receiving signaling that identifies specific remote control commands available for the responsive electrical device 18.

The processing circuitry 20 in one or more embodiments is configured to adapt the user interface 46 or 62 to provide one or more control mechanisms corresponding to the default or specific remote control commands available for the electrical device. For example, physical or touchscreen controls are mapped to corresponding remote control actions.

As for determining that a given electrical device in the surrounding physical environment 12 is a type of responsive electrical device 18, the processing circuitry 20 in one or more embodiments is configured to determine that the electrical device is a type of responsive electrical device 18, based on any one or more of: performing object recognition processing on one or more camera images of the surrounding physical environment 12; processing one or more camera images of the surrounding physical environment 12 to detect and read physical indicia associated with the electrical device; or receiving local wireless signaling advertising the electrical device.

To deem any given electrical device in the surrounding physical environment 12 to be of interest to the user 14, the processing circuitry 20 in one or more embodiments is configured to: determine that the electrical device lies in a detected gaze direction of the user 14; or determine that the user is gesturing at the electrical device or physical controls associated therewith. Additionally, or alternatively, to deem a given electrical device to be of interest to the user 14, the processing circuitry 20 is configured to determine that the electrical device appears within a live field of view of a camera included in or associated with the portable electronic device 10.

FIGS. 3A and 3B illustrate example implementations, where the portable electronic device 10 comprises a head mounted display 70 or a pair of smart glasses 72, with either one including an optoelectronic assembly 74 that includes a camera 76 for imaging a field of view corresponding to a head orientation of the user 14, and a display 78 for displaying the camera image to the user 14, with processing support for VR/AR overlays. In at least one such embodiment, the processing circuitry 20 is configured to recognize the electrical device via object recognition processing of camera images obtained via the camera 74.

FIGS. 4A and 4B illustrate a smartphone 80, as another example implementation of the portable electronic device 10. The smartphone 80 includes a touchscreen 82, a front camera 84, and one or more rear cameras 86, for imaging the surrounding physical environment 12. For example, the smartphone 80 executes a computer program that configures it for discovering, identifying, and controlling responsive electrical devices 18 in the surrounding physical environment 12. In at least one such embodiment, the smartphone 80 scans the environment with one or more of its cameras or monitors for wireless signaling advertising the availability of one or more responsive electrical devices 18. Further, in at least one such embodiment, the smartphone 80 overlays control graphics on its touchscreen 82, in conjunction with displaying at least that portion of the surrounding physical environment 12 that includes a responsive electrical device 18, or physical controls associated therewith. The control graphics are mapped to respective ones among the remote control commands available for the targeted responsive electrical device 18.

FIG. 5 illustrates a smartwatch 90, as an example of the companion device 60. The smartwatch 90 has a touchscreen 92 and may have one or more knobs or other physical controls 94, such as a rotating crown or bezel. The smartwatch 90 further includes wireless communication circuitry 66, for communicating with the portable electronic device 10 via local signaling or via an Internet connection. In an example scenario, the portable electronic device 10 uses the user interface 62 of the companion device 60 to serve as the control input for receiving user inputs that represent corresponding remote control commands. In this sense, for some types of responsive electrical devices 18 or in at least some circumstances, it may be more intuitive or convenient for the user to interact with the user interface 62 of the companion device 60, rather than the user interface 46 included in the portable electronic device 10.

With the above example details in mind, the portable electronic device 10 may be understood as being configured to: (1) determine that there is an electrical device in a surrounding physical environment 12 of a user 14 that is (a) remotely controllable by the portable electronic device 10 and (b) is targeted by the user for remote control; (2) determine the particulars needed for remotely controlling the targeted electrical device—i.e., available commands, protocols, etc.; (3) adapt a user interface to serve as a control input for receiving user inputs; and (4) transmit remote control commands corresponding to received user inputs.

Item (1) is accomplished by, for example, inferring that the user 14 is or may be interested in remotely controlling an electrical device in the surrounding physical environment 12, such as based on gesturing, gaze direction, etc., and determining or otherwise verifying that the electrical device is remotely controllable by the portable electronic device 10. One mechanism for such determination is based on the processing circuitry 20 of the portable electronic device 10 being configured to determine whether a corresponding digital actuation function exists for the electrical device.

Here, a digital actuation function is a data structure, and it may be a digital “twin” of the responsive electrical device 18 at issue, i.e., a full digital model of the responsive electrical device 18. In a simpler embodiment, the digital actuation function is a collection of data identifying the device, such as in terms of its model number, Medium Access Control (MAC) address, or other identifier used for addressing or identifying the responsive electrical device 18 for purposes of remote control, the available remote control commands, and any information needed to issue such as commands to or for the responsive electrical device 18.

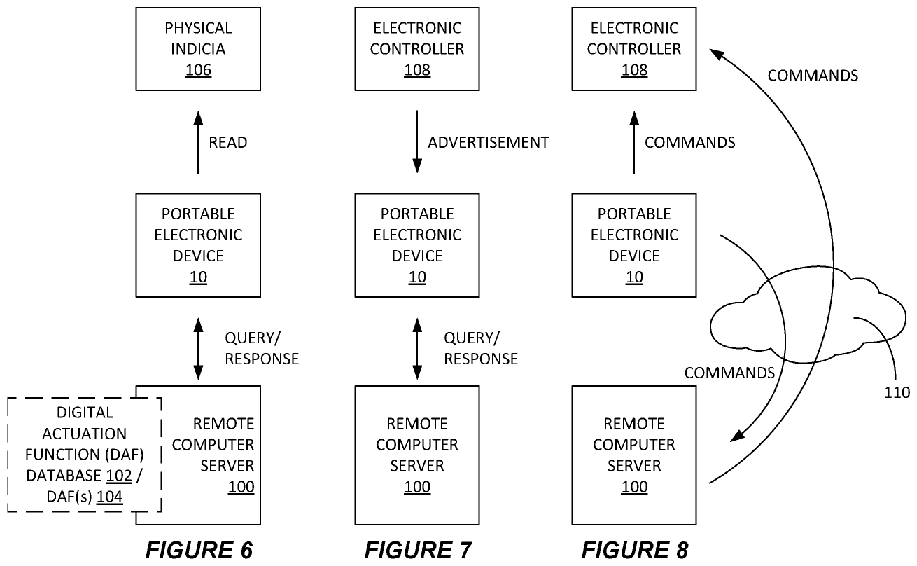

As shown in FIGS. 6, 7, and 8, in one or more embodiments, a remote computer server 100 maintains a database 102 of digital actuation functions (DAFs) 104, with respective DAFs 104 corresponding to individual responsive electrical devices 18 that have been registered for remote control operation by or through the remote computer server 100. Of course, the mapping between responsive electrical devices 18 and DAFs 104 may be many to one, such that a single DAF 104 or copies thereof serve all registered electrical devices that are of a same type or class, or otherwise have the same remote control actions available for them.

Thus, in one or more embodiments, in order to determine whether a corresponding DAF 104 exists for an electrical device in the surrounding physical environment 12, the processing circuitry 20 is configured to determine an identifier of the electrical device, transmit a query indicating the identifier, and determine whether the corresponding DAF 104 exists for the electrical device based on contents of a query response received by the portable electronic device 10. The processing circuitry 20 transmits the query as wireless signaling conveying the query, for example, with the wireless signaling output via the communication circuitry 30. The signaling may comprise Wireless Local Access Network (WLAN) signaling or cellular Wide Area Network (WAN) signaling.

In at least one embodiment, the query is transmitted to a remote computer server 100, based on using a cellular Wide Area Network (WAN) as an access network for contacting the remote computer server, and the processing circuitry 20 is further configured to receive the query response from the remote computer server 100 via the cellular WAN, and evaluate contents of the query response. Alternatively, the query and response are based on Wi-Fi or other WLAN connectivity of the portable electronic device 10. Broadly, the remote computer server 100 is, for example, an Internet-based server and the portable electronic device 10 uses its communication circuitry 30 to establish an IP-based connection with the remote computer server 100.

The response may include a copy of the DAF 104 applicable for the electrical device to be controlled, or it may simply confirm the existence of a DAF 104 for the electrical device. In either case, the portable electronic device 10 determines that the electrical device can be remote controlled by it, based on verifying that a DAF 104 exists for exercising such control. By copying the DAF 104 to the portable electronic device 10, the portable electronic device 10 may generate and transmit remote control commands directly, e.g., using local signaling to the electrical device. Alternatively, the portable electronic device 10 may generate and transmit remote control commands indirectly, e.g., by exchanging signaling with the remote computer server 100, which responsively generates and transmits the actual remote control commands, e.g., as IP signaling addressed to the electrical device.

As for initial discovery of the electrical device, FIG. 6 indicates one approach, wherein the portable electronic device 10 images all or a portion of the surrounding physical environment 12 and correspondingly detects and reads physical indicia 106, such as a QR code or other printed pattern that is present in the environment and identifies a corresponding one or more responsive electrical devices 18. The physical indicia 106 may carry a device identifier or other information needed for sending the DAF query to the remote computer server 100.

FIG. 7 highlights another approach that may be used in other embodiments or under other circumstances. Here, the portable electronic device 10 receives an advertisement comprising local wireless signaling, such as Bluetooth or other low-power radio signaling. Alternatively, such signaling is received via the companion device 60. In any case, the advertisement makes the portable electronic device 10 aware of the existence of the electrical device and provides it with an identifier or other information needed to form the DAF query. It may be that not every electrical device transmitting advertisements is registered with the remote computer server 100 for remote control, with individual responses returned by the remote computer server 100 indicating whether any given advertised electrical device has a defined DAF 104, for carrying out remote control.

Thus, in at least one embodiment, the processing circuitry 20 of the portable electronic device 10 determines whether a corresponding DAF 104 exists for a given electrical device is based on the processing circuitry 20 being configured to detect local wireless signaling from an electronic controller 108 that is integrated in the electrical device or otherwise present in the surrounding physical environment 12 and configured to control the electrical device.

FIG. 8 illustrates that carrying out the remote control may be based on the portable electronic device 10 transmitting remote control commands as local wireless signaling or may be based on transmitting commands to the remote computer server 100, which “relays” them to the electrical device in question—i.e., to the electronic controller 108 of the electrical device in question, such as by Internet-based signaling via the Internet 110. Relaying commands by the remote computer server 100 may mean relaying commands as received from the portable electronic device 10, or reformatting or regenerating commands, to accommodate formatting, protocols, etc., that are specific to the electrical device in question.

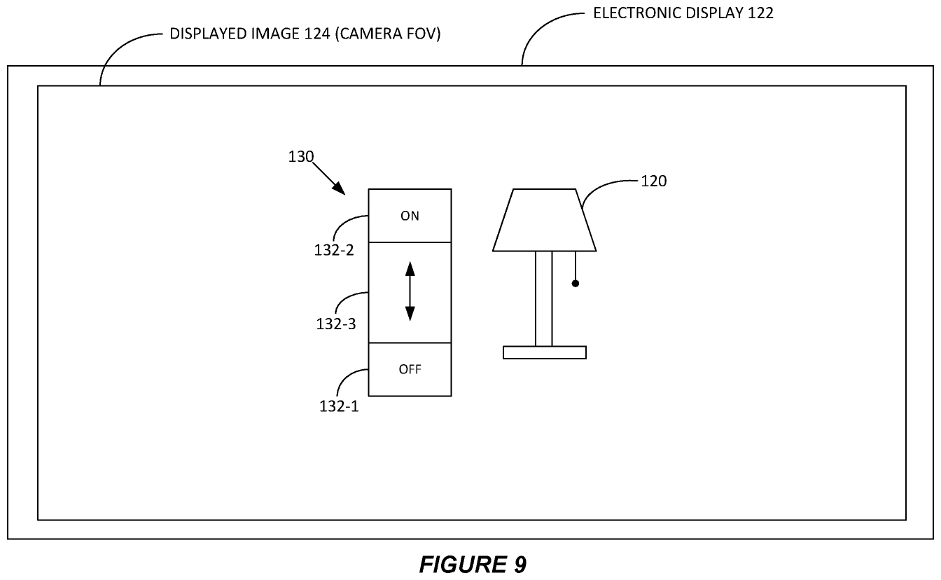

In one or more embodiments, the processing circuitry 20 is configured to recognize that an electrical device has at least on and off states, based on performing object recognition processing on one or more images of the surrounding physical environment 12, and to adapt a user interface to provide mechanisms for the user to initiate at least on and off control commands for the electrical device. FIG. 9 illustrates a corresponding example.

The portable electronic device 10 processes camera images to detect and recognize the presence of a lamp 120, for example. Based on determining that the lamp 120 is remotely controllable by the portable electronic device 10, such as by confirming the existence of a DAF 104 for controlling the lamp 120, the processing circuitry 20 controls an electronic display 122 included in the portable electronic device 10 or in a companion device 60 to display a camera image 124 that contains the image of the lamp 120 and overlays or otherwise superimposes a control graphic 130 in proximity to the displayed image of the lamp 120. Here, the control graphic 130 is an example of the “control input” referred to earlier, wherein the processing circuitry 20 adapts a user interface to serve as a control input for remotely controlling a responsive electrical device 18.

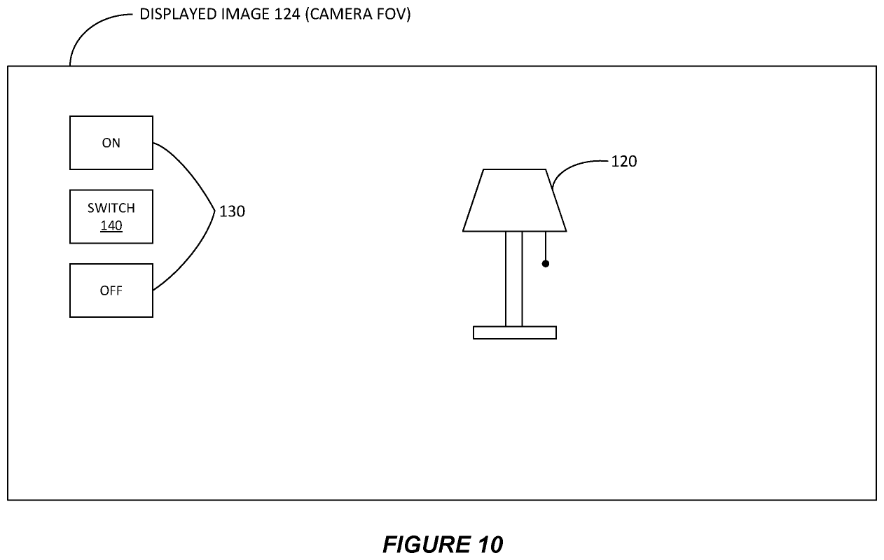

The displayed image 124 is a live view of the FOV of the camera, for example, with the control graphic 130 being dynamically positioned in relation to the location of the image of the lamp 120 within the displayed image 124. The control graphic 130 includes, for example, a first graphical control element 132-1 that is mapped to an off command for the lamp 120, a second graphical control element 132-2 that is mapped to an on command for the lamp 120, and a third graphical control element 132-3 that is mapped to brightness commands for the lamp 120. The electronic display 122 is a touchscreen, for example, and the graphical control element 132-3 may be a “slider” area that allows continuous or stepwise dimming or brightening of the lamp 120. FIG. 10 offers a variation on the arrangement shown in FIG. 9, wherein the control graphic 130 is positioned in relation to a physical control that is used for controlling the lamp 120, such as a light switch 140.

In general terms, adapting a user interface to act as the control input for remote control of a given electrical device, means that the processing circuitry is configured to map one or more control elements of the user interface to corresponding remote control commands defined for the electrical device. With respect to displaying a control graphic such as the control graphic 130, the processing circuitry 20 transmits signaling conveying the remote control commands corresponding to the user inputs received via the control input. That is, the processing circuitry 20 in at least one embodiment is configured to detect touch inputs directed to the control graphic, map the detected touch inputs to corresponding remote control commands from among the defined remote control commands, and transmit the corresponding remote control commands.

In a particular example, the portable electronic device 10 is one of a smartphone 80, a virtual reality headset 70, or a pair of virtual reality glasses 72, and the companion device 60 comprises a smartwatch 90. The user interface adapted for remote control is the user interface of the smartwatch 90, which may comprise a touchscreen 92 and/or physical controls 94, such as a movable bezel. For adapting the user interface, the processing circuitry 20 in this example embodiment is configured to exchange signaling with the smartwatch 90, for configuration of the user interface of the smartwatch for remotely controlling the electrical device.

In at least one embodiment, the portable electronic device 20 includes or is associated with a VR display that provides the user 14 with an augmented reality view of the surrounding physical environment 12. Here, for transmitting signaling conveying remote control commands corresponding to user inputs received via the control input, the processing circuitry 20 is configured to superimpose a control graphic in the virtual reality display, detect user actions directed to the control graphic, translate the user actions into corresponding remote control commands, and transmit the corresponding remote control commands.

The control graphic indicates available remote control commands for the electrical device, and the portable electronic device 10 detecting user actions directed to the control graphic in VR space comprises, for example, detecting one of user gestures or user eye focus and determining targeted ones of the available remote control commands. In at least one such embodiment, the processing circuitry 20 is configured to provide haptic feedback to the user 14 via the user interface, in coordination with one or both of receiving the user inputs and transmitting the remote control commands. Referring back to the user interface 46 of the portable electronic device shown in FIG. 2, for example, there may be one or more motors or other vibrators controllable by the processing circuitry 20. Haptic feedback, however provided, may be differentiated haptic feedback, for differentiation of different command types.

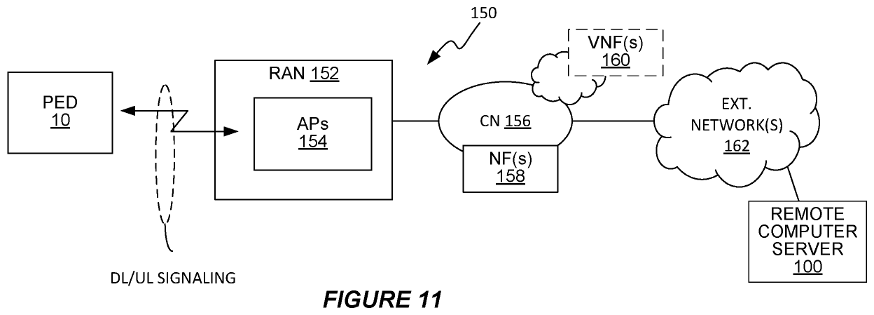

FIG. 11 illustrates an example configuration of the portable electronic device 10 (“PED” in the diagram) and a corresponding communication arrangement in the form of a wireless communication network 150. The network 150 comprises, for example, a cellular communications network configured according to specifications promulgated by the Third Generation Partnership Project (3GPP).

The network 150 includes a Radio Access Network (RAN) 152, which includes one or more radio access points (APs) 154. In a Fifth Generation (5G) New Radio (NR) context of 3GPP specifications, the APs 154 are referred to as “gNBs”.

A core network (CN) 156 includes various network functions (“NFs”) 158, for authenticating and managing connectivity with user equipments (UEs), with the portable electronic device 10 being an example UE. One or more such functions may be implemented as a virtual NF (“VNF”) 160, e.g., in a cloud processing environment. In any case, the CN 156 communicatively couples to one or more external networks 162, such as the Internet, which allows the wireless communication network 150 to serve as an access network for communicatively coupling the portable electronic device 10 to the remote computer server 100 and/or to the electronic controller 108—i.e., smart controller—of a responsive electrical device 18 that is targeted for remote control.

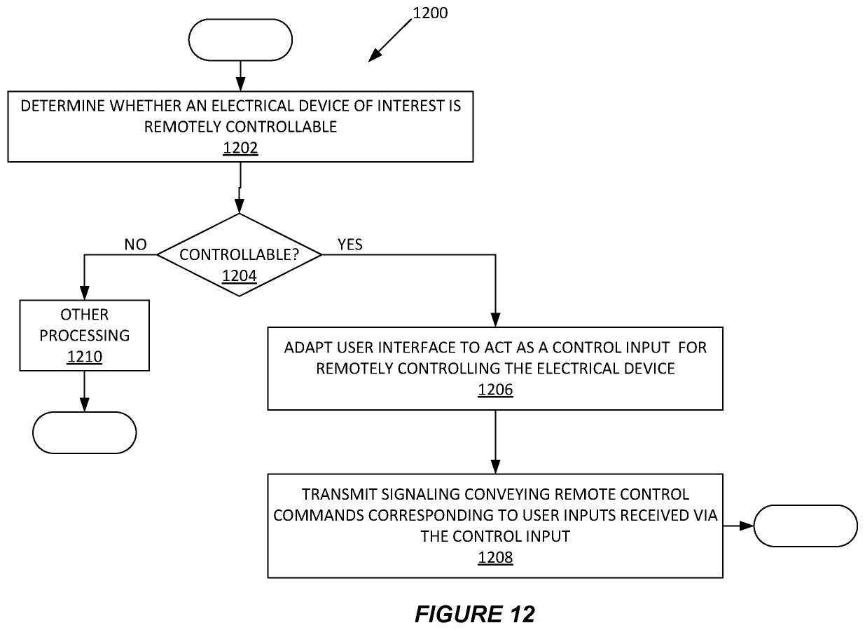

FIG. 12 illustrates a method 1200 of operation by a portable electronic device 10. The method 1200 includes: determining (Block 1202) whether an electrical device deemed to be of interest to a user 14 carrying or wearing the portable electronic device 10 is remotely controllable by the portable electronic device 10. Here, the electrical device is in the surrounding physical environment 12 of the user 14, and the processing labeled as Block 1202 may include or be preceded by processing that identifies the electrical device as being of interest, e.g., based on user gaze detection, user gesture detection, or at least recognizing that the electrical device is within a current camera field of view. The “being of interest” determination may be more speculative in nature, such as by determining that there is at least one responsive electrical device 18 in the surrounding physical environment 12 that is remotely controllable by the portable electronic device 10 and assuming that the user 14 is interested in remotely controlling one or more of those detected responsive electrical devices 18.

Turning back to the method 1200, responsive to determining that the electrical device deemed to be of interest is remotely controllable by the portable electronic device 10 (YES from Block 1204), the method 1200 further includes: adapting (Block 1206) a user interface of the portable electronic device or a companion electronic device to act as a control input for remotely controlling the electrical device; and transmitting (Block 1208) signaling conveying remote control commands corresponding to user inputs received via the control input, for remote control of the electrical device. Other processing (Block 1210) is performed, such as continuing to detect whether there are other electrical devices in the surrounding physical environment 12 that are remotely controllable, if the electrical device currently deemed to be of interest to the user 14 is not remotely controllable (NO from Block 1204).

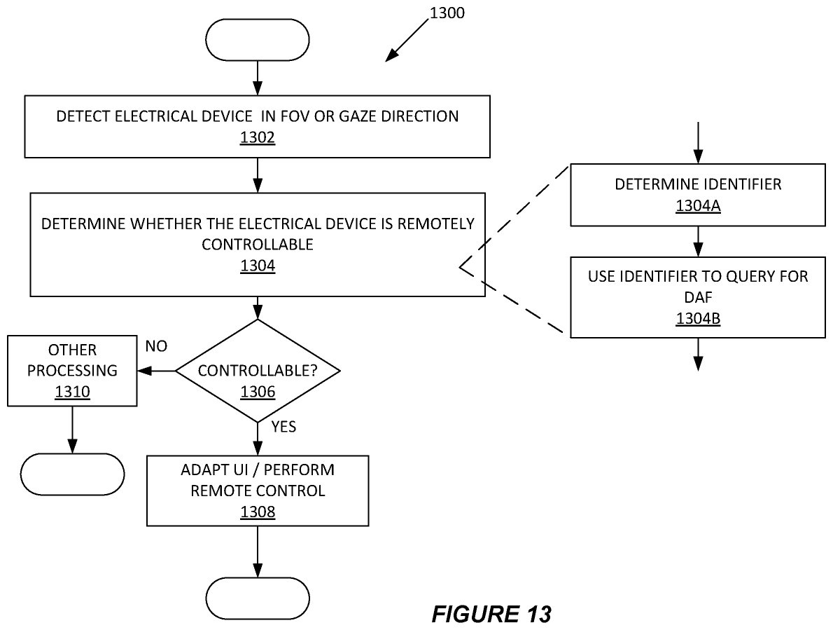

FIG. 13 illustrates a method 1300 that may be considered part of or an extension to the method 1200. The method 1300 includes a portable electronic device 10 detecting (Block 1302) that an electrical device is in a current camera FOV or specifically in a gaze direction of the user 14, and deeming from that detection that the electrical device is of interest to the user 14. From there, the method 1300 continues with determining (Block 1304) whether the electrical device is remotely controllable by the portable electronic device 10, which may comprise determining (Block 1304A) an identifier for the electrical device and using (Block 1304B) the identifier to query a remote computer server 100 for a DAF 104 corresponding to the electrical device.

If the electrical device is controllable (YES from Block 1306), the method 1300 continues with adapting a user interface (UI) for remote control of the electrical device and performing remote control operations, e.g., responding to user inputs directed to the UI (Block 1308). If the electrical device is not controllable (NO from Block 1308), the method 1300 continues with other processing 1310, such as continuing to scan for electrical devices that are candidates for control.

Broadly, the illustrated steps or operations of the method 1200 or 1300 may include any of the operations described above for the processing circuitry 20. For example, either method may include performing object recognition on camera images to identify electrical devices or control switches therefor present in the surrounding physical environment 12 and may include interacting directly or indirectly with an electronic controller 108 of a responsive electrical device 18, for effecting remote control. Direct interaction may be via local wireless signaling, while indirect interaction may be through a remote computer server 100. Further, for determining that a given electrical device is remotely controllable by the portable electronic device 10, the method 1200 may include the portable electronic device querying a remote computer server 100, to determine whether a DAF 104 exists for the electrical device.

In at least one example, a portable electronic device 10 includes processing circuitry 20, such as a microprocessor, and includes a memory storing computer program instructions that, when executed by the microprocessor, cause the portable electronic device 10 to infer that an electrical device in the surrounding physical environment 12 is targeted by a user for remote control, such as by determining that the user is looking at or gesturing at the electrical device, or at a switch or other physical control associated therewith. This operation can be understood as an example of the portable electronic device 10 “deeming” a particular electrical device in the surrounding physical environment 12 to be of interest to the user—i.e., a target device. Thus, an aspect of processing in one or more embodiments is the portable electronic device 10 recognizing one or more cues that indicate a desire on the part of the user 14 to control a given electrical device within the surrounding physical environment 12, and such processing may include the further or parallel step of determining that the given device is remotely controllable by the portable electronic device 10.

Further, execution of the program instructions may cause the portable electronic device 10 to determine an identifier of the target device, such as by receiving local wireless signaling, processing captured images to read visible indicia, determining location coordinates for the target device, etc. Still further, execution of the computer program instructions cause the portable electronic device 10 to use the identifier for querying a remote computer server 100, e.g., based on use of communication circuitry 30 included in the portable electronic device 10, and to receive a query response that indicates a DAF 104 corresponding to the target device, if one is available for the target device. In one embodiment, the DAF 104 is a data structure that indicates available commands and may indicate user-interface (UI) adaptation, signaling protocols, network addresses for sending commands, etc. In at least one embodiment, execution of the computer program instructions causes the portable electronic device 10 to use the DAF 104 for configuring remote control of the target device. Here, using the DAF 104 may include downloading it to the portable electronic device 10, or the use may be based on interacting with the DAF 104 as stored at the remote computer server 100.

In embodiments where the portable electronic device 10 comprises a head mounted display (HMD), such as the headset 70 seen in FIG. 3A, remote control inputs may be received from the user 14 in a VR/AR context, such as by projecting a control graphic 130 onto a live camera view of the surrounding physical environment 12, including a live image of the electrical device to be controlled, and detecting user gestures or user eye focus as inputs directed to the control graphic 130. Such operations may be enhanced by providing haptic feedback to the user 14, in conjunction with the user 14 directing input to the control graphic 130. If, during such interactions, the user redirects her gaze elsewhere, the portable electronic device 10 may drop out of the remote-control mode temporarily, e.g., until the user 14 again focuses on the electrical device and/or the associated control graphic 130. For example, the control graphic 130 may be deleted from the display or dimmed or otherwise made inactive, responsive to detecting that the attention of the user has turned elsewhere.

Such operations include determining that an electrical device is of plausible interest to the user for remote control, based on detecting that the electrical device is within a current camera field of view or, more particularly, is being gazed at by the user. Object recognition processing may be extended to determine the logical attributes of the electrical device in question, such as whether it is an on/off device, a speed-control device, etc.

In at least some embodiments, the decision regarding which user interface to adapt for controlling the electrical device may be based on one or more of user preferences, a user profile, or detected circumstances. For example, the user 14 may not have a companion device 60 or may prefer not to use the companion device 60, or the user 14 may have recorded preferences that indicate the circumstances under which a companion device 60 should or should not be used in the remote control operations.

As noted above, some companion devices may be especially suited for remote control operations. For example, a smartwatch 90 may have a rotating bezel that serves as an intuitive control input for continuous or graduated input control, such as dimming or brightening a lamp, decreasing or increasing a thermostat setting for a HVAC system, raising or lowering the volume of a smart speaker, etc. In this regard, the decision of whether to use a companion device 60 may be based at least in part on the portable electronic device 10 determining the logical attributes of the electrical device in question.

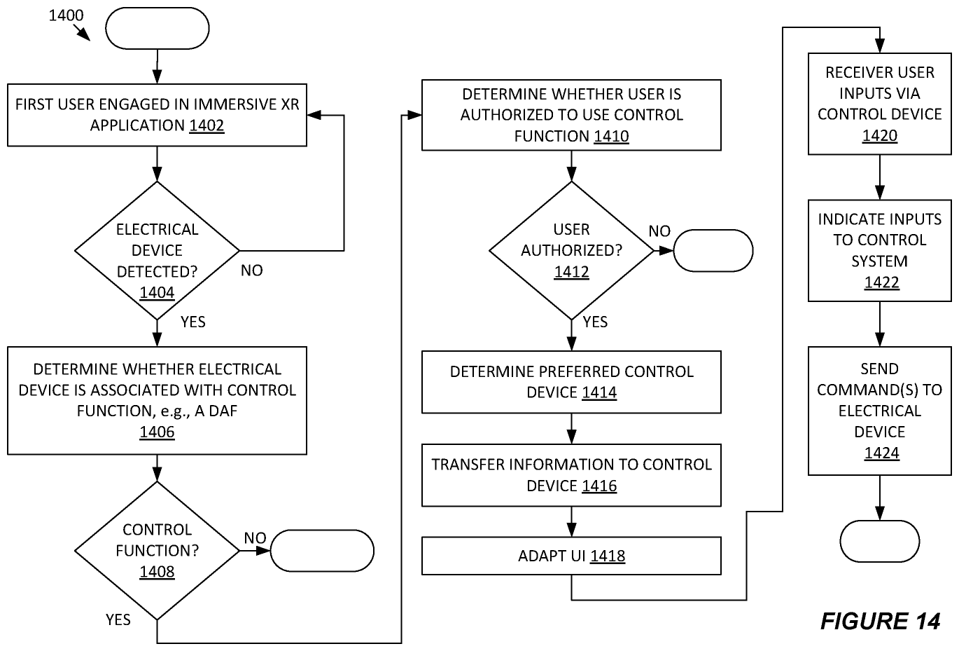

FIG. 14 illustrates an overall method 1400 that represents an example use case, a first user is engaged in some extended Reality (XR) immersive use in her home (Block 1402). Here, XR denotes AR or VR, and generally includes mixed reality, where scenes of a physical environment are augmented with one or more VR elements.

The first user is wearing a HMD or smart glasses as an example of a portable electronic device 10, with the HMD or smart glasses performing image processing/object recognition to detect electrical devices in the surrounding environment that are plausible for remote control (Block 1404). If not, processing loops, with continued searching for electrical devices, as part of or in parallel with other XR processing. If yes, processing continues with determining (Block 1406) whether a control function exists for the detected electrical device, e.g., checking for a DAF 104.

If a control function is not available (NO from Block 1408), the processing flow ends, which may be understood as returning to the scanning/detecting of Block 1402, for example. If a control function is available (YES from Block 1408), the processing flow continues with determining whether the first user is authorized to control the electrical device (Block 1410), e.g., it may be a thermostat, TV, or other device that has limited access for one or more particular users or classes of users.

If the first user is not authorized (NO from Block 1412), the processing flow ends, which may be understood as returning to the scanning/detecting of Block 1402, for example. If the first user is authorized (YES from Block 1412), the processing flow continues with determining (Block 1414) a preferred control device for the first user, e.g., based on a user profile, past behavior, recorded preferences, etc. This step can be understood as determining which electronic device(s) the first user will use, for remote control of the electrical device, with the options including, for example, a primary device or a companion device.

Processing continues with transferring (Block 1416) information to the electronic device that will act as the control device, where such information may be defined remote control commands, information about the control graphic to display, etc., with the control device adapting its user interface (UI) or an interface in an associated device (Block 1418). The control device then receives one or more user inputs (Block 1420), with the control device indicating (Block 1422) those inputs to a “control system” that actually effectuates the remote control, e.g., generates and transmits the remote control commands, or causes them to be generated and transmitted. The control system may be a functional module implemented within the control device or an associated device in communication with the control device, or it may be a remote device or system, such as the remote computer server 100 described earlier. In any case, the control system sends (Block 1424) commands to the electrical device, representing the remote control inputs received from the user.

In a more detailed example, the home of a first user may be amongst others equipped with a home automation solution to manage light sources as well as room temperature and air ventilation; the home automation solution may be hosted by a server that, in turn, via wireless communication, is connected to individual light sources and clusters thereof, and corresponding associated control actuators. Light sources may have capabilities of communication over low-energy Bluetooth (BLE), Wi-Fi, VLC, or similar. Assuming visible light communications (VLC) capabilities of light sources, a VLC identification sequence for each source may typically be known by the system.

Thus, in an example scenario, the first user gazes towards a light source e.g., with the intention to manipulate either intensity (dimming) of light source, or on/off state, depending on current initial state). Via gaze detection, the headset 70 resolves targeted light source from potentially many candidate light sources in the current field of view and determines a VLC sequence vs1 from said light source.

An XR managing server, which may be running in the HMD worn by the user, in one approach may request, from a light source managing server, digital attributes associated with the targeted light source, e.g., based on acquiring an identifier of the targeted light source via VLC. Alternatively, the XR managing server, as an example of a computer server, may have such information available from some initial pairing/setup operations. Depending on policies and authorization steps, the light source managing server responds with the requested digital attributes e.g., as (i) <dimmable:yes, on/off:yes, master-function-of-cluster-X:yes>. For a light source that cannot be dimmed and is part of a certain light cluster, the digital attributes may include (ii) <dimmable: no, on/off:yes, master-function-of-cluster-X:no>. A light source that is not controllable in this context may have the following digital attributes (iii) <dimmable: no, on/off:no, master-function-of-cluster-X:no>. If the light is controllable, the digital attributes may include the specific command sequences corresponding to on, off, dimmer, brighter, etc.

The XR managing server interprets the obtained information, and deduces that e.g., for the scenario (i) that the first user should be presented with a control input that provides two means to interact with light source; one twisting haptic action to dim the light source and one linear representation associated with the on/off state.

According to user's preference as obtained from a user setting with XR managing server, the dim-twist haptic action is preferably associated with her smart watch in terms of the physical bezel being overlaid with a control rendering and with haptic sensation of a “virtual bezel” being associated with the operation of the light source dimming. The XR managing server then assigns/associates the virtual twist to the dimming action and also to the smartwatch. The XR managing server then, assuming that the first user gazes towards her smartwatch, starts rendering the selected overlayed light control bezel. Where smart watch is capable of rendering a haptic sensation associated with the bezel, the bezel may be rendered also with certain protrusions e.g., indicating partial rotation steps, etc. Such operations may, of course, be adapted for a physical bezel if the smartwatch has one.

In a similar aspect, where the first user has a smartphone available, in addition to or as an alternative to a smartwatch, the XR managing server may associate rendering overlays and define corresponding haptic stimulus for a touchscreen of the smartphone. For example, the XR managing server displays linear on/off toggle e.g., as a slider, and/or a toggle-knob on the touchscreen of the smartphone.

In example user input-scenarios, the light source managing receiver may receive a control request message from the XR managing server, where the request carries a light source ID and an associated control command; e.g., <light source id vs1, “30% down”>, and/or <light source id vs1, off> or similar. The light source managing server may then execute accordingly and, for example, dim the light source having the indicated ID, and it may return an acknowledgment (ACK) to the XR managing server, indicating execution of the command.

In another embodiment, a VLC sequence could be comprised of different access codes, with one access code corresponding to users having full access and with another access code corresponding to users with more limited access. More broadly, remote control operations may be divided into an overall set accessible to fully authorized users, and a smaller subset of those operations available to limited-authorization users. One approach to categorizing users into fully authorized or having limited authorization may be based on URLs associated with the respective portable electronic device(s) of such users. For example, a user attempting to perform remote control via a portable electronic device 10 that is connected to a closed Wi-Fi network may be deemed fully authorized. Conversely, a user that is not connected to the closed Wi-Fi network may be deemed as having limited authorization.

In these and other contexts, a portable electronic device 10 may implement a server function that manages remote control operations, possibly in combination with communicating with one or more other servers, such as a server that maintains DAFs 104 for registered electrical devices, and/or a server that acts as a control network or control supervisor for the electrical devices that are candidates for remote control. The DAF server and/or the control server may be remote from the residence, building, or other location in which the electrical devices are located, and communications may be IP-based signaling.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-44. (canceled)

45. A method of operation by a portable electronic device, the method comprising:
determining whether an electrical device deemed to be of interest to a user carrying or wearing the portable electronic device is remotely controllable by the portable electronic device, the electrical device being in a surrounding physical environment of the user;
responsive to determining that the electrical device is remotely controllable by the portable electronic device:
adapting a user interface of the portable electronic device or a companion electronic device to act as a control input for remotely controlling the electrical device; and
transmitting signaling conveying remote control commands corresponding to user inputs received via the control input, for remote control of the electrical device.

46. The method according to claim 45, further comprising deeming the electrical device to be of interest to the user based at least on determining that the electrical device is a type of responsive electrical device.

47. The method according to claim 46, further comprising determining available remote control commands for the electrical device based on stored information that defines default remote control commands available for one or more types of responsive electrical devices or based on receiving signaling that identifies specific remote control commands available for the electrical device.

48. The method according to claim 47, wherein adapting the user interface comprises adapting the user interface to provide one or more control mechanisms corresponding to the default or specific remote control commands available for the electrical device.

49. The method according to claim 46, wherein determining that the electrical device is a type of responsive electrical device comprises one of: performing object recognition processing on one or more camera images of the surrounding physical environment; processing one or more camera images of the surrounding physical environment to detect and read physical indicia associated with the electrical device; or receiving local wireless signaling advertising the electrical device.

50. The method according to claim 46, wherein deeming the electrical device to be of interest to the user further comprises determining at least one of:
that the electrical device lies in a detected gaze direction of the user; or
that the user is gesturing at the electrical device.

51. The method according to claim 46, wherein deeming the electrical device to be of interest to the user further comprises determining that the electrical device appears within a live field of view of a camera included in or associated with the portable electronic device.

52. The method according to claim 45, wherein the portable electronic device comprises a head mounted display or a pair of smart glasses and includes a camera for imaging a field of view corresponding to a head orientation of the user, and wherein the method further comprises recognizing the electrical device via object recognition processing of camera images obtained via the camera.

53. The method according to claim 45, wherein determining whether the electrical device deemed to be of interest to the user is remotely controllable by the portable electronic device comprises determining whether a corresponding digital actuation function exists for the electrical device.

54. The method according to claim 53, wherein determining whether the corresponding digital actuation function exists for the electrical device comprises detecting local wireless signaling from an electronic controller that is integrated in the electrical device or otherwise present in the surrounding physical environment.

55. The method according to claim 54, wherein determining whether the corresponding digital actuation function exists for the electrical device comprises determining an identifier of the electrical device, transmitting a query indicating the identifier, and determining whether the corresponding digital actuation function exists for the physical device based on contents of a query response received by the portable electronic device.

56. The method according to claim 55, wherein transmitting the query comprises transmitting wireless signaling conveying the query, the wireless signaling comprising Wireless Local Access Network (WLAN) signaling or cellular Wide Area Network (WAN) signaling.

57. The method according to claim 55, wherein transmitting the query comprises transmitting the query to a remote computer server, based on using a cellular Wide Area Network (WAN) as an access network for contacting the remote computer server, receiving the query response from the remote computer server via the cellular WAN, and evaluating contents of the query response.

58. The method according to claim 55, further comprising determining the identifier based on processing one or more images of the electrical device or associated physical indicia, as acquired by the portable electronic device via a camera included in or associated with the portable electronic device.

59. The method according to claim 45, wherein the method includes recognizing the electrical device as an electrical device having at least on and off states, based on performing object recognition processing on one or more images of the surrounding physical environment, and wherein adapting the user interface comprises adapting the user interface to provide mechanisms for the user to initiate on and off control commands for the electrical device.

60. The method according to claim 45, wherein adapting the user interface to act as the control input for remote control of the electrical device comprises mapping one or more control elements of the user interface to corresponding remote control commands defined for the electrical device.

61. The method according to claim 60, wherein the user interface comprises a touchscreen and wherein adapting the user interface to act as the control input for remote control of the electrical device comprises displaying a control graphic on the touchscreen, and wherein transmitting the signaling conveying the remote control commands corresponding to the user inputs received via the control input comprises detecting touch inputs directed to the control graphic, mapping the detected touch inputs to corresponding remote control commands from among the defined remote control commands, and transmitting the corresponding remote control commands.

62. The method according to claim 45, wherein the portable electronic device is one of a smartphone, a virtual reality headset, or a pair of virtual reality glasses, wherein the companion device comprises a smartwatch, wherein the user interface is the user interface of the smartwatch, and wherein adapting the user interface comprises the portable electronic device exchanging signaling with the smartwatch, for configuration of the user interface of the smartwatch for remotely controlling the electrical device.

63. The method according to claim 45, wherein the portable electronic device includes or is associated with a virtual reality display that provides the user with an augmented reality view of the surrounding physical environment, and wherein transmitting signaling conveying remote control commands corresponding to user inputs received via the control input comprises superimposing a control graphic in the virtual reality display, detecting user actions directed to the control graphic, translating the user actions into corresponding remote control commands, and transmitting the corresponding remote control commands.

64. A portable electronic device comprising:
communication circuitry; and
processing circuitry configured to:
determine whether an electrical device deemed to be of interest to a user carrying or wearing the portable electronic device is remotely controllable by the portable electronic device, wherein the electrical device is in a surrounding physical environment of the user;
responsive to determining that the electrical device is remotely controllable by the portable electronic device:
adapt a user interface of the portable electronic device or a companion electronic device to act as a control input for remotely controlling the electrical device; and
transmit, via the communication circuitry, signaling conveying remote control commands corresponding to user inputs received via the control input, for remote control of the electrical device.
